(19) United States
(12) Patent Application Publication
(10) Pub. No.: US 2004/0173248 A1
(43) Pub. Date: Sep. 9, 2004

(54) Ultrasonic vibrator, wet-treatment nozzle, and wet-treatment apparatus

(75) Inventors: Kenichi Mitsumori, Miyagi-ken (JP); Nobuaki Haga, Miyagi-ken (JP); Shoichi Ono, Miyagi-ken (JP)

Correspondence Address: Anthony P.Curtis, Ph.D., BRINKS HOFER GILSON & LIONE, P.O. BOX 10395, CHICAGO, IL, 60610, US

(73) Assignee: Alps Electric Co., Ltd.

(21) Appl. No.: 10/801,476

(22) Filed: Mar. 16, 2004

Related U.S. Application Data
(62) Division of application No. 09/946,113, filed on Sep. 4, 2001.

(30) Foreign Application Priority Data
Sep. 7, 2000 (JP) 2000-272137

(51) Int. Cl. B08B 3/10

(52) U.S. Cl. 134/64 R; 134/122 R; 134/184; 134/186; 134/104.2; 134/198

(57) ABSTRACT

An ultrasonic vibrator includes a diaphragm, a side plate which stands on the principal surface of the diaphragm, and a vibrator body placed inside the side plate on the principal surface of the diaphragm in order to apply ultrasonic vibration to the diaphragm. The diaphragm has a thin portion at least in a part of the periphery of an area where the vibrator body is placed. A wet-treatment nozzle includes a supply pipe having, at one end, an inlet for admitting a treatment liquid, a drain pipe having, at one end, an outlet for discharging the waste liquid to the outside after wet treatment, and a connecting portion which faces a workpiece and which connects the other ends of the supply pipe and the drain pipe. The ultrasonic vibrator is placed in the connecting portion of the wet-treatment nozzle.

### BACKGROUND OF THE INVENTION

1. Field of the Invention

The present invention relates to an ultrasonic vibrator, a wet-treatment nozzle, and a wet-treatment apparatus. More particularly, the present invention relates to a technique suitably used for cleaning in.the manufacturing procedure of semiconductor devices, liquid crystal display panels, and the like.

2. Description of the Related Art

In the fields of electronic devices, such as semiconductor devices and liquid crystal display panels, it is essential to clean semiconductor substrates and glass substrates in the manufacturing procedure. In the cleaning process, it is necessary to remove organic substances adhering to the surfaces of the substrates. In this case, for example, wet treatment for cleaning substrates by bringing the substrates into contact with various kinds of cleaning liquids or dry treatment for applying ultraviolet (UV) rays to substrates can be selected.

In wet treatment, cleaning is performed using various kinds of cleaning liquids, such as ultrapure water, electrolytic ion water, ozone water, and hydrogen water, in order to remove various substances in the manufacturing process. The cleaning liquids are supplied from wet-treatment nozzles of a wet-treatment apparatus onto substrates to be treated.

FIG. 12 shows an example of a conventional wet-treatment nozzle provided in such a wet-treatment apparatus. The wet-treatment nozzle has a main body 95 composed of an outer casing 91 having a convex portion 91a protruding toward a substrate 90 to be treated, and an inner casing 92 placed inside the outer casing 90 with a space 93, which functions as a flow path for passing a treatment liquid 100, therebetween. The inner casing 92 is composed of a diaphragm 96, and a side plate 97 which stands on both ends of the principal surface of the diaphragm 96 so as to hold the diaphragm 96. The side plate 97 is formed integrally with the diaphragm 96. A treatment liquid inlet 95a is formed at one end of the main body 95 so as to supply the treatment liquid 100 into the space 93. A treatment liquid discharging slit 95b is formed in the convex portion 91a, and is opened toward the substrate 90. A treatment liquid outlet 95c is formed at the other end of the main body 95 so as to drain the remaining treatment liquid 100 which is not discharged from the treatment liquid discharging slit 95b. An ultrasonic vibrator body 98 for applying ultrasonic vibration to the diaphragm 96 is bonded onto the principal surface of the diaphragm 96 inside the side plate 97. The ultrasonic vibrator body 98 is connected to an ultrasonic oscillator 99. In this type of wet-treatment nozzle, the side plate 97, the diaphragm 96, the ultrasonic vibrator body 98, and the ultrasonic oscillator 99 constitute an ultrasonic vibrator.

In the wet-treatment nozzle with such a configuration, the treatment liquid 100 supplied from the treatment liquid inlet 95a into the flow path 93 flows under the diaphragm 98, and is discharged from the treatment liquid discharging slit 95b onto the substrate 90. The remaining treatment liquid 100 is drained through the treatment liquid outlet 95c. In this case, ultrasonic vibration is applied from the ultrasonic vibrator body 98 to the diaphragm 96, is reflected toward the ultrasonic vibrator body 98 by the inner wall of the outer casing 91, and is reflected again toward the inner wall by the ultrasonic vibrator body 98. The ultrasonic vibration is repeatedly reflected between the ultrasonic vibrator body 98 and the outer casing 91, and is converged at the treatment liquid discharging slit 95b. The converged ultrasonic vibration is applied to the treatment liquid 100, and cleans the substrate 90 disposed below the treatment liquid discharging slit 95 in cooperation with the treatment liquid 100.

However, the conventional wet-treatment nozzle shown in FIG. 12 consumes a large amount of treatment liquid.

Accordingly, the present inventors have proposed a liquid-saving wet-treatment nozzle which can substantially reduce the consumption of cleaning liquid, compared with the conventional cleaning nozzle.

FIG. 13 shows an example of such a liquid-saving wet-treatment nozzle. The wet-treatment nozzle comprises a supply pipe 101 having, at one end, an inlet 101a for admitting a treatment liquid 100, a drain pipe 102 having, at one end, an outlet 102a for draining the treatment liquid 100 to the outside after the wet-treatment operation, and a connecting portion 103 which faces a substrate 90 to be treated and which connects the other ends of the supply pipe 101 and the drawing pipe 102. The connecting portion 103 includes a first opening 101b which opens to the supply pipe 101, and a second opening 102b which opens to the drain pipe 102. A treatment region 105 where wet treatment is performed is formed between the connecting portion 103 and the substrate 90. An ultrasonic vibrator is placed in the connecting portion 103 in order to apply ultrasonic vibration to the cleaning liquid 100 in the treatment region 105. The ultrasonic vibrator is constituted by a diaphragm 96, a side plate 97 which stands on both ends of the principal surface of the diaphragm 96, and a vibrator body 108 placed on the principal surface of the diaphragm 96. The vibrator body 108 is connected to a power supply (not shown). The outlet 102a of the drain pipe 102 is connected to a pressure-reducing pump (not shown).

The treatment liquid 100 is supplied from the inlet 110a of the supply pipe 101 and reaches the first opening 101b. Since the pressure-reducing pump (not shown) is connected to the outlet 102a of the drain pipe 102, the difference between the pressure of the treatment liquid 100 supplied to the supply pipe 101 which is in contact with the atmosphere at the first opening 101b (including the surface tension of the treatment liquid 100 and the surface tension of the surface of the substrate 90 to be treated), and the atmospheric pressure can be controlled by adjusting the suction force of the pressure-reducing pump.

That is, by ensuring that the pressure P_{w} of the treatment liquid 100 in contact with the atmosphere at the first opening 101b (including the surface tension of the treatment liquid 100 and the surface tension of the surface of the substrate 90), and the atmospheric pressure Pₐ have the relationship P_{w}≈Pₐ, the treatment liquid 100 supplied to be in contact with the substrate 90 through the first opening 101b can be discharged through the drain pipe 102 without leaking out of the wet-treatment nozzle. For this reason, the wet-treatment nozzle shown in FIG. 13 can substantially reduce the consumption of treatment liquid, compared with the nozzle shown in FIG. 12.

In the nozzle shown in FIG. 13, since ultrasonic vibration is applied from the vibrator body 108 while the treatment liquid 100 is supplied into the treatment region 105, and the substrate 90 can be cleaned with the ultrasonic vibration and the treatment liquid 100 used in combination.

In both the conventional wet-treatment nozzles shown in FIGS. 12 and 13, however, the radiation efficiency of ultrasonic vibration from the diaphragm 96 having the vibrator body bonded thereto to the treatment liquid 100 is low. This is because, even when ultrasonic vibration is applied to the diaphragm 96 from the vibrator body, vibration of the side plate 96 formed integrally with the diaphragm 96 is not transmitted to the treatment region, resulting in energy loss. Therefore, in wet-treatment apparatuses having such conventional wet-treatment nozzles, the cleaning to input power efficiency is low, and an excessive amount of power must be used in order to obtain sufficient vibration energy for cleaning.

### SUMMARY OF THE INVENTION

The present invention has been made in view of the above circumstances, and it is an object of the invention to provide an ultrasonic vibrator which can prevent ultrasonic vibration applied from a vibrator body to a vibrating portion from leaking from a side wall portion.

Another object of the present invention is to provide a wet-treatment nozzle which can improve the radiation efficiency of ultrasonic vibration from a vibrating portion having a vibrator body to treatment liquid.

A further object of the present invention is to provide a wet-treatment apparatus which ensures a high cleaning to input power efficiency.

In order to overcome the above problems, according to a first aspect of the present invention, there is provided an ultrasonic vibrator including a vibrating portion, a side wall portion standing on the principal surface of the vibrating portion, and a vibrator body disposed on the principal surface of the vibrating portion inside the side wall portion so as to apply ultrasonic vibration to the vibrating portion, wherein the vibrating portion has a thin portion formed at least in a part of the periphery of an area where the vibrator body is placed.

In this ultrasonic vibrator of the first aspect, ultrasonic vibration is propagated from the vibrator body to the vibrating portion. Since the vibrating portion has the thin portion formed at least in a part of the periphery of an area where the vibrator body is placed, the propagated ultrasonic vibration is partly reflected by the thin portion, is prevented from leaking from the side wall portion, and is efficiently radiated from the surface opposite from the principal surface of the vibrating portion (the surface opposite from the surface where the vibrator body is placed).

According to a second aspect of the present invention, there is provided an ultrasonic vibrator including a vibrating portion, a side wall portion standing on the principal surface of the vibrating portion, and a vibrator body disposed on the principal surface of the vibrating portion inside the side wall portion so as to apply ultrasonic vibration to the vibrating portion, wherein a thin portion is formed at least on a part of the border between the vibrating portion and the side wall portion.

In this ultrasonic vibrator of the second aspect, ultrasonic vibration is propagated from the vibrator body to the vibrating portion. Since the thin portion is formed at least on a part of the border between the vibrating portion and the side wall portion, the propagated ultrasonic vibration is partly reflected by the thin portion, is prevented from leaking from the side wall portion, and is efficiently radiated from the surface opposite from the principal surface of the vibrating portion (the surface opposite from the surface where the vibrator body is placed).

Furthermore, since the vibrating portion has no thin portion on the periphery of the area where the vibrator body is placed, that is, has no unused portion outside the thin portion, when the radiation efficiency of ultrasonic vibration is set the same as that of the above ultrasonic vibrator, the size of the vibrating portion can be made smaller than that of the above ultrasonic vibrator. This makes it possible to provide a smaller and lighter ultrasonic vibrator.

Preferably, the vibrating portion is made of stainless steel, quartz, sapphire, or ceramic such as alumina. While stainless steel is satisfactory as the material of the vibrating portion in a wet-treatment nozzle for normal cleaning operation, when a treatment liquid is a relatively strong acid or a hydrofluoric acid, it is preferable to use sapphire or ceramic such as alumina because it is highly resistant to a wet-treatment liquid and deterioration can be avoided.

In the above ultrasonic vibrator of the first or second aspect, the thickness of the vibrating portion is preferably within the range of λ/2±0.3 mm where λ represents the wavelength inside the vibrating portion of ultrasonic vibration applied from the vibrator body, and more preferably, is within the range of λ/2±0.1 mm. By setting the thickness of the vibrating portion within the range of λ/2±0.3 mm, ultrasonic vibration from the vibrator body can be effectively propagated. By using a cleaning nozzle with such an ultrasonic vibrator having excellent characteristics, ultrasonic vibration (ultrasonic energy) is sufficiently applied to the treatment liquid, and wet treatment is made more efficient.

The frequency of the ultrasonic vibration is preferably within the range of 20 kHz to 10 MHz. This makes it possible to perform practical ultrasonic cleaning when wet treatment is performed by a wet-treatment nozzle having the ultrasonic vibrator.

Since the thin portion is formed at least in a part of the periphery of an area of the vibrating portion, where the vibrator body is placed, or at least on a part of the border between the vibrating portion and the side wall portion, a groove is formed on the vibrating portion, or at least on a part of the border between the vibrating portion and the side wall portion.

Preferably, the depth of the groove is within the range of 0.1 mm to (the thickness of the vibrating portion—0.1 mm), and more preferably, is within the range of (the thickness of the vibrating portion—2.0 mm) to (the thickness of vibrating portion—0.1 mm). In order to prevent ultrasonic vibration propagated to the vibrating portion from leaking from the side wall portion, it is preferable to set the depth of the groove within the above range. By performing wet treatment with a wet-cleaning nozzle having such an ultrasonic vibrator, ultrasonic vibration (ultrasonic energy) can be effectively used for wet treatment.

The width of the groove (thin portion) is preferably within the range of 0.01 mm to 10.0 mm. By setting the width of the groove (thin portion) within the above range, the groove (thin portion) can be stably formed on the vibrating portion or on the border between the vibrating portion and the side wall portion by grooving, and ultrasonic vibration propagated to the vibrating portion is prevented from leaking from the side wall portion. Ultrasonic vibration can be effectively used for wet treatment by using a cleaning nozzle having the ultrasonic vibrator.

One or more grooves (thin portions) may be formed. The grooves may be closed around the vibrator body or around the vibrating portion, that is, may be connected to one another. Alternatively, the grooves may be unconnected.

This makes it possible to prevent ultrasonic vibration propagating to the vibrating portion from leaking from the side wall portion. By performing wet treatment with a wet-treatment nozzle having such an ultrasonic vibrator, ultrasonic vibration can be effectively used for wet treatment.

According to a third aspect of the present invention, there is provided a wet-treatment nozzle for supplying a treatment liquid for the wet treatment of a workpiece toward the workpiece and for discharging the waste treatment liquid after wet treatment, wherein the nozzle includes a supply pipe having, at one end, an inlet for admitting the treatment liquid, a drain pipe having, at one end, an outlet for draining the waste liquid to the outside, and a connecting portion which faces the workpiece and which connects the other ends of the supply pipe and the drain pipe, wherein the connecting portion has a first opening which opens to the supply pipe and a second opening which opens to the drain pipe, wherein a treatment region for wet treatment that is filled with the treatment liquid is formed in a space between the opposing surfaces of the connecting portion and the workpiece by supplying the treatment liquid from the first opening toward the workpiece, wherein the connecting portion includes the ultrasonic vibrator according to the above first or second aspect of the present invention so as to apply ultrasonic vibration to the treatment liquid in the treatment region, and wherein the waste liquid from the treatment region is guided from the second opening into the drain pipe and is drained through the outlet.

Since the ultrasonic vibrator according to the above first or second aspect of the present invention for applying ultrasonic vibration to the treatment liquid in the treatment region is placed in the connecting portion of the wet-treatment nozzle, ultrasonic vibration propagated from the vibrator body is efficiently radiated from the surface of the vibrating portion opposite from the principal surface (the surface opposite from the surface where the vibrator body is placed) to the treatment liquid in the treatment region, and satisfactory wet treatment can be performed due to a sufficient cooperation of the treatment liquid and the ultrasonic vibration.

Furthermore, since the treatment liquid, which is supplied from the supply pipe onto the surface of the workpiece and contains contaminants (substances removed from the workpiece), can be drained through the drain pipe without coming into contact with the portions of the workpiece other than the portion where the treatment liquid is supplied. A high level of cleanliness can be achieved. Moreover, since the treatment liquid can be drained without leaking out of the nozzle by controlling the suction force from the outlet with respect to the pressure of the treatment liquid at the first opening, a sufficient level of cleanliness can be obtained with only a small amount of treatment liquid.

According to a fourth aspect of the present invention, there is provided a wet-treatment apparatus including the above wet-treatment nozzle, and a nozzle and workpiece relatively moving means for cleaning the entire treatment region of a workpiece by relatively moving the wet-treatment nozzle and the workpiece along the surface of the workpiece.

In this case, the entire region of the workpiece to be treated can be treated while maintaining the advantages of the wet-treatment nozzle of the present invention, and it is possible to provide a wet-treatment apparatus which ensures a high cleaning to input power efficiency.

Further objects, features, and advantages of the present invention will become apparent from the following description of the preferred embodiments with reference to the attached drawings.

### BRIEF DESCRIPTION OF THE DRAWINGS

FIG. 1 is a bottom view of a cleaning nozzle according to a first embodiment of the present invention.

FIG. 2 is a sectional view of the cleaning nozzle, taken along line II-II in FIG. 1.

FIG. 3 is a sectional view showing another example in which cleaning nozzles are placed on the upper and lower sides of a substrate to be cleaned.

FIG. 4 is a bottom view of a cleaning nozzle according to a second embodiment of the present invention.

FIG. 5 is a sectional view of the cleaning nozzle, taken along line V-V in FIG. 4.

FIG. 6 is a sectional view showing another example in which cleaning nozzles are placed on the upper and lower sides of a substrate to be cleaned.

FIG. 7 is a general structural plan view of a cleaning apparatus according to a third embodiment of the present invention.

FIG. 8 is a chart showing the results of measurements of the sound pressures of ultraviolet waves radiated from ultraviolet vibrator bodies of cleaning nozzles according to first and second examples and first and second comparative examples.

FIG. 9 is a view showing a method for measuring the sound pressures of ultraviolet waves radiated from the ultraviolet vibrator bodies of the cleaning nozzles according to the first and second examples and the first and second comparative examples.

FIG. 10 is a chart showing the result of comparison among the widths of the cleaning nozzles according to the first and second examples and the first comparative example.

FIG. 11 is a chart showing the result of comparison among the weights of the cleaning nozzles according to the first and second examples and the first comparative example.

FIG. 12 is a sectional side view of a conventional wet-treatment nozzle.

FIG. 13 is a sectional side view of a conventional liquid-saving wet-treatment nozzle.

### DESCRIPTION OF THE PREFERRED EMBODIMENTS

Preferred embodiments of the present invention will be described below with reference to the attached drawings.

[First Example]

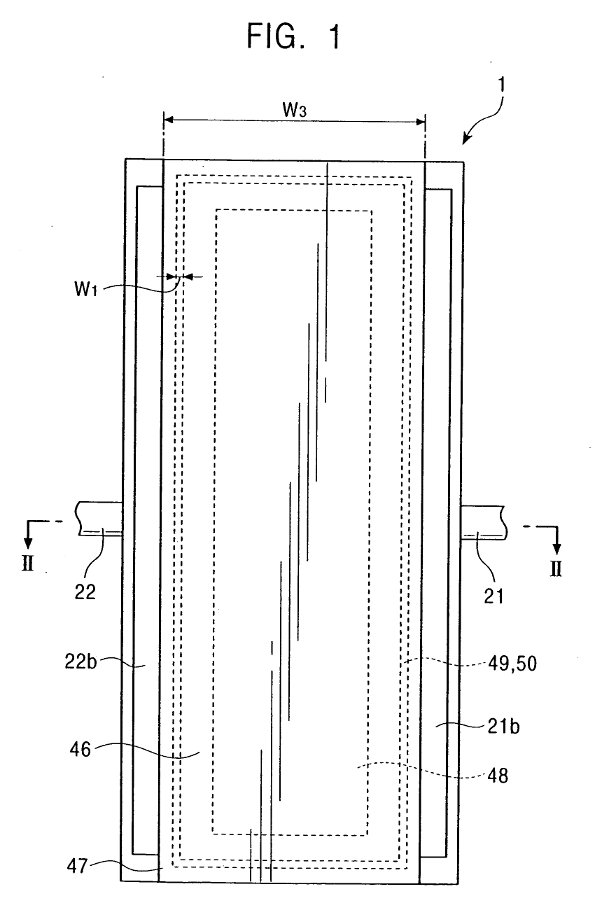

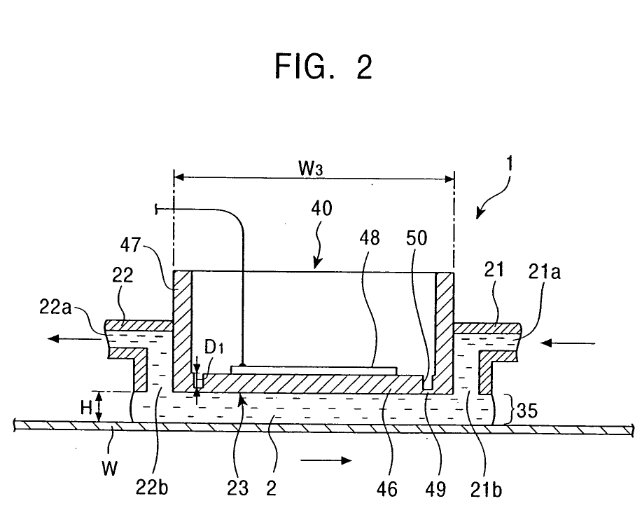

FIG. 1 is a bottom view of a cleaning nozzle (wet-treatment nozzle) having an ultrasonic vibrator according to a first embodiment of the present invention, and FIG. 2 is a sectional view of the cleaning nozzle, taken along line II-II in FIG. 1.

A cleaning nozzle 1 of the first embodiment includes a supply path (supply pipe) 21 having, at one end, an inlet 21a for admitting a cleaning liquid (treatment liquid) 2, and a drain path (drain pipe) 22 having, at one end, an outlet 22a for draining a cleaning liquid after cleaning (waste liquid after wet treatment). The other ends of the supply path 21 and the drain path 22 are connected to each other to form a connecting portion 23 which faces a substrate W to be treated (a workpiece to be treated). The connecting portion 23 includes a first opening 21b which opens to the supply path 21, and a second opening 22b which opens to the drain path 22. The cleaning nozzle 1 is called a “push-pull nozzle (liquid-saving nozzle)”. The first and second openings 21b and 22b are opened to the substrate W. A treatment region 35 where wet treatment is performed is formed between the connecting portion 23 and the substrate W.

An ultrasonic vibrator 40 is placed in the connecting portion 23 in order to apply ultrasonic vibration to the cleaning liquid 2 in the treatment region 35 while the substrate W is being cleaned. The ultrasonic vibrator 40 comprises a diaphragm (vibrating portion) 46, a side plate (side wall portion) 47 which stands on the peripheral portion of the principal surface of the diaphragm 46, and an vibrator body 48 disposed inside the side plate 47 on the principal surface of the diaphragm 46 to apply ultrasonic vibration to the diaphragm 46. The side plate 47 is formed integrally with the diaphragm 46. The vibrator body 48 is connected to a power supply (not shown).

The diaphragm 46 and the side plate 47 are made of stainless steel, quartz, sapphire, or ceramic such as alumina. While stainless steel is satisfactory as the material of the diaphragm and side plate in a wet-treatment nozzle for normal cleaning operation, when the cleaning liquid is a relatively strong acid or a hydrofluoric acid, sapphire or ceramic such as alumina is preferable because it is highly resistant to the wet-treatment liquid and will not deteriorate.

The diaphragm 46 has a thin portion 49 formed around an area where the vibrator body 48 is placed, so that the area is surrounded by a groove 50 on the principal surface of the diaphragm 46. The thickness of the diaphragm 46 is preferably within the range of λ/2±0.3 mm, where A represents the wavelength inside the diaphragm 46 of ultrasonic vibration applied from the vibrator body 48, and more preferably, is within the range of λ/2±0.1 mm. By setting the thickness of the diaphragm 46 within the range of λ/2±0.3 mm, ultrasonic vibration from the vibrator body 48 can be effectively propagated. Performing wet treatment using the cleaning nozzle 1 having the ultrasonic vibrator 40 makes it possible to sufficiently apply ultrasonic vibration (ultrasonic energy) to the cleaning liquid 2, thereby making the wet treatment more efficient.

In order to prevent the ultrasonic vibration propagated to the diaphragm 46 from leaking through the side plate 47, it is preferable that the depth D₁ of the groove 50 be set within the range of 0.1 mm to (the thickness of the diaphragm 46-0.1 mm), and more preferably, within the range of (the thickness of the diaphragm 46-2.0 mm) to (the thickness of the diaphragm 46-0.1 mm). By performing wet treatment using the cleaning nozzle 1 having the ultrasonic vibrator 40 in which the depth D₁ of the groove 50 is set within the above range, ultrasonic vibration (ultrasonic energy) can be effectively used for wet treatment.

In order to stably form the groove 50 on the diaphragm 46 by grooving and to prevent ultrasonic vibration propagated to the diaphragm 46 from leaking through the side plate 47, the width W₁ of the groove 50 (thin portion 49) is preferably within the range of 0.01 mm to 10.0 mm. By setting the width W₁ of the groove 50 (thin portion 49) within the above range, ultrasonic vibration can be effectively used for wet treatment using the cleaning nozzle 1 having the ultrasonic vibrator 40.

In order to perform practical ultrasonic cleaning, it is preferable that the vibrator body 48 be able to output ultrasonic vibration having frequencies ranging from 20 kHz to 10 MHz. In particular, it is more preferable that the frequency be more than or equal to 0.2 MHz, in order to from the viewpoint of the retainable thickness of the cleaning liquid layer.

When the diaphragm 46 is made of stainless steel (SUS 316L), the wavelength λ in the diaphragm 46 of ultrasonic vibration applied from the vibrator body 48 is within the range of 0.57 mm to 28.5 mm.

A pressure control section (not shown) is disposed on the side of the drain path 22 in order to attain a balance between the pressure of the cleaning liquid in contact with the atmosphere at the first opening 21 (including the surface tension of the cleaning liquid and the surface tension of a surface of a substrate W to be cleaned) and the atmospheric pressure so that the cleaning liquid 2, which has come into contact with the substrate W, flows into the drain path 22 after cleaning.

The pressure control section is formed of a pressure-reducing pump disposed on the side of the outlet 22a. Therefore, the pressure of the cleaning liquid in contact with the atmosphere at the first opening 21b (including the surface tension of the cleaning liquid and the surface tension of a surface of a substrate to be cleaned) and the atmospheric pressure are balanced by controlling the suction force of the cleaning liquid in the connecting portion 23 by using the pressure-reducing pump in the pressure control section on the side of the drain path 22. In other words, by ensuring that the pressure P_{w} of the cleaning liquid in contact with the atmosphere at the first opening 21b (including the surface tension of the cleaning liquid and the surface tension of a surface of a substrate to be cleaned) and the atmospheric pressure Pₐ have the relation P_{w}≈Pₐ the cleaning liquid, which is supplied to be in contact with the substrate W via the first opening 21b, can be drained through the drain path 22 without leaking out of the cleaning nozzle 1. That is, the cleaning liquid supplied from the cleaning nozzle 1 is removed from the substrate W without coming into contact with the portions of the substrate W other than the portions where it is supplied (the first and second openings 21b and 22b).

Ultrasonic vibration is applied from the vibrator body 48 while the cleaning liquid 2 is being supplied to the treatment region 35, and the substrate W can be cleaned with the ultrasonic vibration and the cleaning liquid 2 used in combination. In the ultrasonic vibrator 40 in the cleaning nozzle 1 of this embodiment, ultrasonic vibration applied from the vibrator body 48 is propagated to the diaphragm 46. Since the diaphragm 46 has the thin portion 49 formed around the area where the vibrator body 48 is placed, the ultrasonic vibration propagated is partly reflected by the thin portion 49, is thereby prevented from leaking through the side plate 47, and is efficiently applied from the surface of the diaphragm 46 opposite from the principal surface (the surface opposite from the surface on which the vibrator body 48 is placed) to the cleaning liquid 2 in the treatment region 35.

The distance H between the openings 21b and 22b of the cleaning nozzle 1 and the substrate W is set to be less than or equal to 8 mm and within a range such that the openings 21b and 22b do not come into contact the substrate W, and is preferably less than or equal to 6 mm and within the above range, and more preferably, less than or equal to 3 mm and within the above range. This is because, when the distance H exceeds 8 mm, it is difficult to fill the space between the substrate W and the cleaning nozzle 1 with a desired cleaning liquid, thus making cleaning difficult.

In order to prevent impurities from eluting into the cleaning liquid, according to the type of the cleaning liquid, it is preferable that the surface of the cleaning nozzle 1 which comes into contact with the cleaning liquid be made of fluorine resin, such as PFA, a passive stainless steel surface wherein the outermost film is made only of chromate, a stainless steel surface having on its front side a mixed film of aluminum oxide and chromate, or an electropolished titanium surface for ozone water. The surface made of quartz is suitable for all the types of cleaning liquids except hydrofluoric acid.

The cleaning nozzle 1 of this embodiment may be used when the cleaning liquid 2 to be supplied to the treatment region 35 is hydrogen water, when the cleaning liquid is ozone water, and when the cleaning liquid is pure water.

In the cleaning nozzle 1 of the first embodiment, the ultrasonic vibrator 40 with the above configuration is provided in the connecting portion 23 in order to apply ultrasonic vibration to the cleaning liquid 2 in the treatment region 35. Therefore, ultrasonic vibration propagated from the vibrator body 48 can be efficiently radiated from the surface of the diaphragm 46 opposite from the principal surface (the surface opposite from the surface where the vibrator body 48 is placed) to the cleaning liquid 2 in the treatment region 35, and satisfactory wet treatment can be performed with a sufficient cooperation of the cleaning liquid 2 and ultrasonic vibration.

Furthermore, the cleaning nozzle 1 of this embodiment comprises the supply path 21 having the inlet 21a, the drain path 22 having the outlet 22a, and the connecting portion 23 which faces a substrate W to be cleaned and which connects the ends of the supply path 21 and the drain path 22. The connecting portion 23 includes the first opening 21b which opens to the supply path 21 and the second opening 22b which opens to the drain path 22. By supplying the cleaning liquid 2 from the first opening 21b toward the substrate W, the treatment region 35 filled with the cleaning liquid 2 is formed in the space between the opposing surfaces of the connecting portion 23 and the substrate W. Waste cleaning liquid from the treatment region 35 is guided from the second opening 22b into the drain path 22, and is discharged from the outlet 22a. In the above configuration, the cleaning liquid 2 supplied from the supply path 21 onto the surface of the substrate W can be discharged outside as waste liquid while containing materials removed from the substrate W, without coming into contact with the portions of the surface of the substrate W other than the portions where the cleaning liquid 2 is supplied, thereby achieving a sufficient level of cleanliness. Furthermore, by controlling the suction force at the outlet 22b with respect to the pressure of the cleaning liquid 2 at the first opening 21b, the cleaning liquid 2 can be discharged without leaking out of the nozzle. This makes it possible to achieve a sufficient level of cleanliness with only a small amount of cleaning liquid.

While one groove 50 is formed on the diaphragm 46 of the ultrasonic vibrator 40 in the cleaning nozzle 1 of this embodiment, and is closed around the vibrator body 48, more than two grooves may be formed. In this case, the grooves may be closed around the vibrator body 48, that is, may be connected to one another. Alternatively, the grooves may be unconnected.

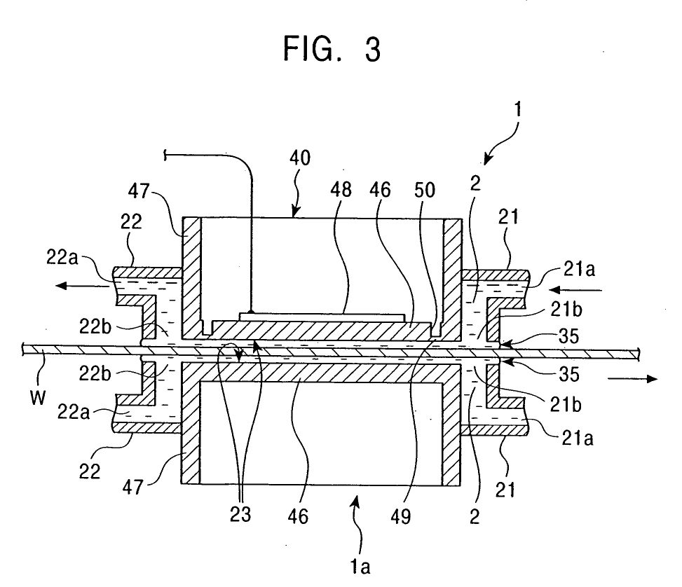

While the cleaning nozzle 1 of this embodiment is placed on the upper side (one surface to be cleaned) of the substrate W, a cleaning nozzle 1a may also be placed on the lower side of the substrate W, as shown in FIG. 3. The cleaning nozzle la has a structure similar to that of the above-described cleaning nozzle 1 except that no vibrator body 48 is disposed in a connecting portion 23. A diaphragm 46 having the above-described thin portion 49 may be placed in the connecting portion 23.

[Second Embodiment]

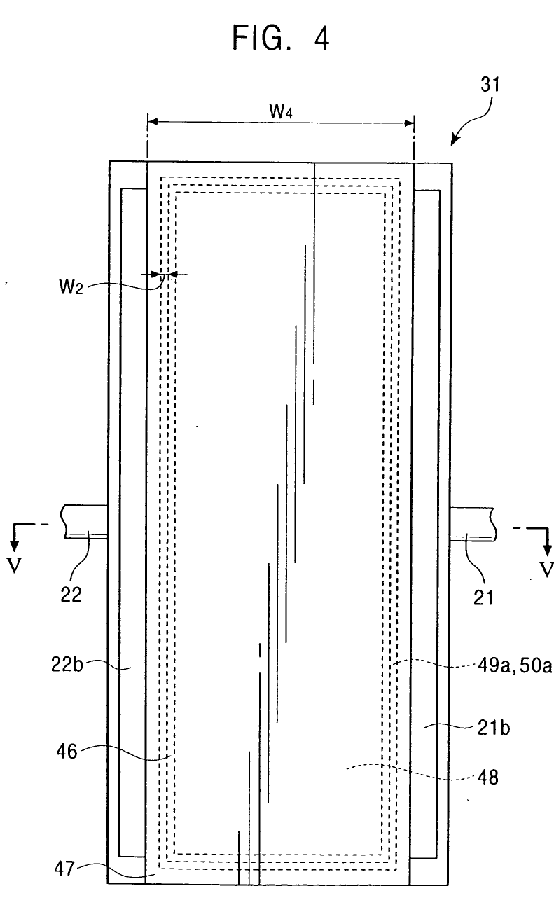

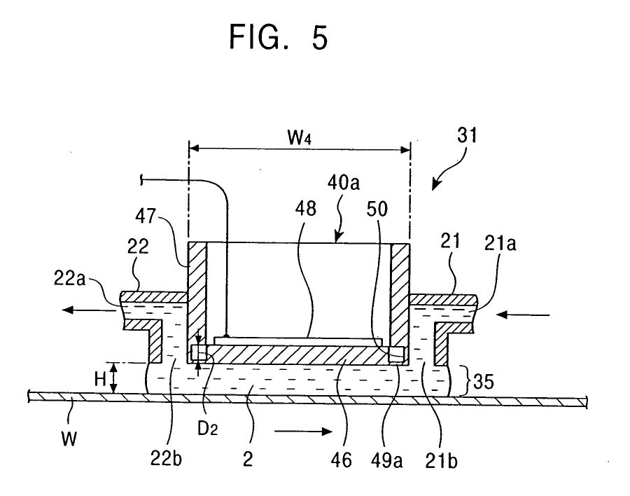

FIG. 4 is a bottom view of a cleaning nozzle (wet-treatment nozzle) having an ultrasonic vibrator according to a second embodiment of the present invention, and FIG. 5 is a sectional view of the cleaning nozzle, taken along line V-V in FIG. 4.

A cleaning nozzle 31 of the second embodiment is different from the cleaning nozzle 1 of the first embodiment shown in FIGS. 1 and 2 in the structure of an ultrasonic vibrator 40a provided in a connecting portion 23.

While the thin portion 49 is formed around the area of the diaphragm 46 where the vibrator body 48 is placed in the ultrasonic vibrator 40 of the first embodiment, a thin portion 49a is formed on the border between a diaphragm (vibrating portion) 46 and a side plate (side wall portion) 47 in the ultrasonic vibrator 40a of the cleaning nozzle 31 in the second embodiment.

Since the above thin portion 49a is formed on the border between the diaphragm 46 and the side plate 47, a groove 50a is formed thereon, so that the diaphragm 46 is surrounded by the groove 50a (thin portion 49a).

In order to prevent ultrasonic vibration propagated to the diaphragm 46 from leaking through the side plate 47, it is preferable that the depth D₂ of the groove 50a be set within the range of 0.1 mm to (the thickness of the diaphragm 46-0.1 mm), and more preferably, within the range of (the thickness of the diaphragm 46-2.0 mm) to (the thickness of the diaphragm 46-0.1 mm).

The width W₂ of the groove 50a (thin portion 49a) is preferably within the range of 0.01 mm to 10.0 mm in order to stably form the groove 50a on the border between the diaphragm 46 and the side plate 47 by grooving and to prevent ultrasonic vibration propagated to the diaphragm 46 from leaking through the side plate 47.

The cleaning nozzle 31 of this embodiment can clean a substrate W, in a manner similar to that of the cleaning nozzle 1 of the first embodiment. In the ultrasonic vibrator 40a of the cleaning nozzle 31 of this embodiment, ultrasonic vibration is radiated from the vibrator body 48 and is propagated to the diaphragm 46. Since the thin portion 49a is formed on the border between the diaphragm 46 and the side plate 47, the propagated ultrasonic vibration is partly reflected by the thin portion 49a, and is thereby prevented from leaking through the side plate 47. Consequently, the ultrasonic vibration is efficiently radiated from the surface of the diaphragm 46 opposite from the principal surface toward the cleaning liquid.

In the ultrasonic vibrator 40a, the thin portion is not formed around the area of the diaphragm 46 where the vibrator body 48 is placed, and therefore, the diaphragm 46 has no unused portion outside the thin portion. Therefore, when the ultrasonic vibrator 40a has the same radiation efficiency as that of the ultrasonic vibrator 40 of the first embodiment, the size of the vibrating portion can be made smaller than that in the first embodiment, and this reduces the size and weight of the ultrasonic vibrator.

Since the ultrasonic vibrator 40a with the above structure is provided in the connecting portion 23 of the cleaning nozzle 31 of the second embodiment so as to apply ultrasonic vibration to the cleaning liquid 2 in the treatment region 35, operations and advantages similar to those of the first embodiment can be obtained. Moreover, since the size and weight of the diaphragm 46 can be reduced when the ultrasonic radiation efficiency is set to be the same in the first embodiment, it is possible to provide a smaller and lighter cleaning nozzle.

While one groove 50a is formed on the border between the diaphragm 46a and the side plate 47 of the ultrasonic vibrator 40a in the cleaning nozzle 31 of this embodiment, and is closed around the diaphragm 46, more than two grooves may be formed. In this case, the grooves may be closed around the vibrator body 48, that is, may be connected to each other. Alternatively, the grooves may be unconnected.

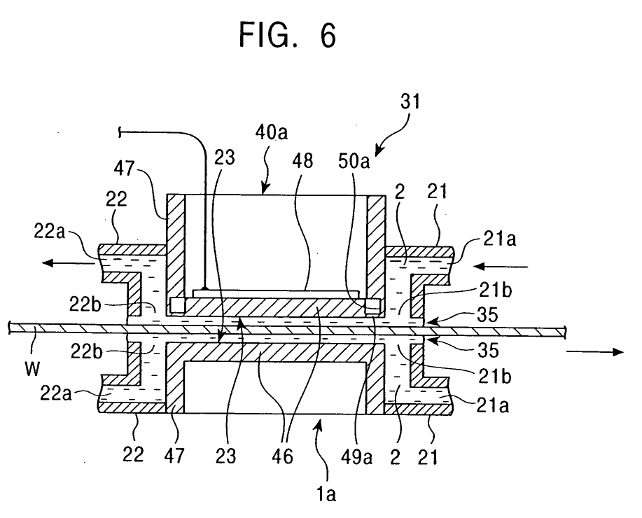

While the cleaning nozzle 31 is placed on the upper side (one surface to be cleaned) of the substrate W in this embodiment, a similar cleaning nozzle 1a may also be placed on the lower side of the substrate W, as shown in FIG. 6. A thin portion 49a may be formed on the border between a diaphragm 46 and a side plate 47 in the cleaning nozzle 1a.

[Third Embodiment]

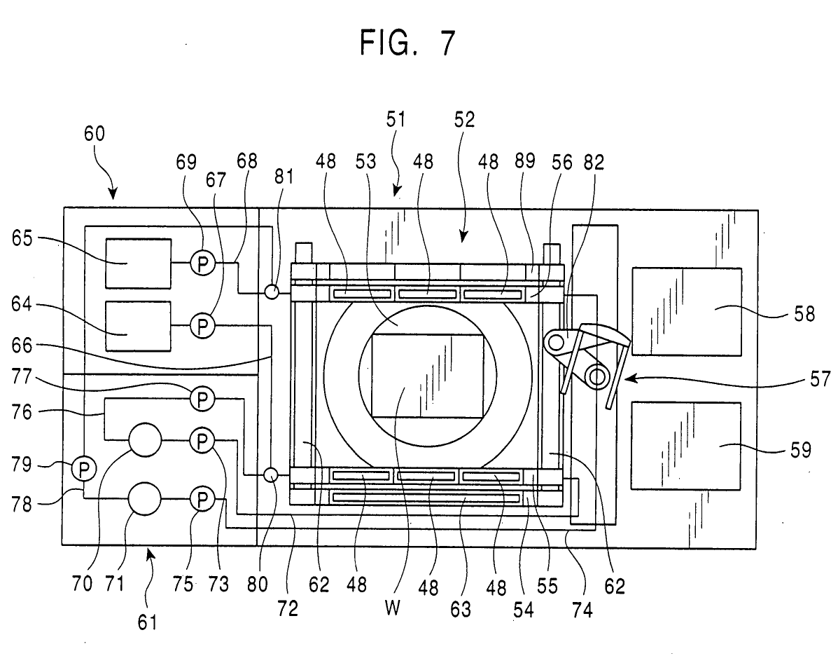

A third embodiment of the present invention will be described below with reference to FIG. 7.

FIG. 7 is a general structural view of an example of a cleaning apparatus (wet-treatment apparatus) 51 having the cleaning nozzle of the above first or second embodiment. The cleaning apparatus 51 subjects, for example, large glass substrates (hereinafter simply referred to as “substrates”) of approximately 200 mm to 900 mm square, serving as substrates to be cleaned, to single-substrate cleaning.

The cleaning apparatus 51 comprises a cleaning section 52, a stage (substrate holding means) 53, cleaning nozzles 54, 55, 56, and 89, a substrate transfer robot 57, a loader cassette 58, an unloader cassette 59, a hydrogen-water/ozone-water generating section 60, and a cleaning-liquid recycling section 61. W represents a glass substrate (substrate to be cleaned).

As shown in FIG. 7, the cleaning section 52 formed on the upper center surface of the apparatus includes the stage 53 for holding a substrate W. A substrate W is fitted in a rectangular stepped portion, which is formed on the stage 53 and conforms to the shape of the substrate W, and is held on the stage 53 while the surface of the substrate W and the surface of the stage 53 are flush with each other. A space is formed under the stepped portion, and a substrate lifting shaft (not shown) protrudes in the space from below the stage 53. A shaft driving source (not shown), such as a cylinder, is disposed at the bottom of the substrate lifting shaft. When a substrate W is transferred by the substrate transfer robot 57, the substrate lifting shaft is vertically moved by the action of the cylinder so as to move the substrate W up and down.

A pair of rack bases 62 are formed opposed to each other with the stage 53 therebetween, and four cleaning nozzles extend between the rack bases 62. The cleaning nozzles are arranged in parallel, and adopt different cleaning methods. In this embodiment, the cleaning nozzles are an ultraviolet cleaning nozzle 54 which principally dissolves and removes organic substances by supplying ozone and irradiating a substrate W with ultraviolet rays from an ultraviolet lamp 63, a hydrogen-water-used ultrasonic cleaning nozzle 55 which cleans a substrate W by applying ultrasonic vibration from a vibrator body 48 while supplying hydrogen water, an ozone-water-used ultrasonic cleaning nozzle 56 which cleans a substrate W by applying ultrasonic vibration from a vibrator body 48 while supplying ozone water, and a pure water rinsing nozzle 89 which performs rinsing with pure water.

The cleaning nozzles 54, 55, 56, and 89 are of a so-called “push-pull” (liquid-saving) type. Among the four nozzles, the ozone-water-used ultrasonic cleaning nozzle 56 and the hydrogen water cleaning nozzle 56 have a structure similar to that in either of the embodiments shown in FIGS. 1 to 6, or are constituted by a plurality of cleaning nozzles according to either of the embodiments (in FIG. 7, the cleaning nozzles include three connecting portions 23 for connecting supply paths 21 and drain paths 22, three ultrasonic vibrators 40 (or ultrasonic vibrators 40a), and three first openings 21b and three second openings 22b formed in the connecting portions 23). For convenience of illustration, however, only the vibrator bodies 48 are shown in FIG. 7, and the components of the supply section and the drain section are not shown. The ultraviolet cleaning nozzle 54 has a structure substantially similar to that of the cleaning nozzles of the above embodiments except that an ultrasonic lamp 63 is substituted for the vibrator body 48. The ultrapure water rinsing nozzle 89 has a structure substantially similar to that of the cleaning nozzles of the above embodiments except that it does not have the ultraviolet body 48. For convenience of illustration, however, the components of the supply section and the drain section are not shown in FIG. 7.

In the cleaning apparatus 51, the four cleaning nozzles sequentially move along the rack bases 62 above a substrate W with a fixed space therebetween, thereby cleaning the entire surface to be cleaned (the entire surface to be treated) of the substrate W by four different cleaning methods.

As a means for moving each cleaning nozzle (a nozzle and workpiece relatively moving means), a slider is used so as to horizontally move along linear guides on the rack bases 62. Both ends of each of the cleaning nozzles 54, 55, 56, and 89 are fixed to columnar supports which stand on the slider. A driving source, such as a motor, is placed on the slider so that the slider can run on the rack bases 62. The motor on the slider is operated according to control signals supplied from the control section (not shown) of the apparatus, thereby individually and horizontally moving the cleaning nozzles 54, 55, 56, and 89. Driving sources (not shown), such as cylinders, are mounted on the columnar supports so as to vertically move the columnar supports. By the vertical movement of the columnar supports, the height of the cleaning nozzle 54, 55, 56, or 89, that is, the space between the cleaning nozzle and the substrate W can be adjusted.

On the side of the cleaning section 52, the hydrogen-water/ozone-water generating section 60 and the cleaning-liquid recycling section 61 are placed. The hydrogen-water/ozone-water generating section 60 incorporates a hydrogen-water producing device 64 and an ozone-water producing device 65. Hydrogen water and ozone water can be produced by dissolving hydrogen gas and ozone gas in pure water. Hydrogen water produced by the hydrogen-water producing device 64 is supplied to the hydrogen-water-used ultrasonic cleaning nozzle 55 by a liquid feeding pump 67 which is placed at the midpoint of a hydrogen-water supply pipe 66. Similarly, ozone water produced by the ozone-water producing device 65 is supplied to the ozone-water-used ultrasonic cleaning nozzle 56 by a liquid feeding pump 69 which is placed at the midpoint of an ozone-water supply pipe 68. Pure water is supplied from a pure-water supply pipe (not shown) in a production line to the pure-water rinsing nozzle 89.

The cleaning-liquid recycling section 61 includes a hydrogen-water filter 70 and an ozone-water filter 71 for removing particles and foreign substances contained in the used cleaning liquid. The hydrogen-water filter 70 serves to remove particles in hydrogen water, and the ozone-water filter 71 serves to remove particles in ozone water. The filters 70 and 71 constitute separate systems. That is, the used hydrogen water (waste liquid) drained through the outlet of the ozone-water-used ultrasonic cleaning nozzle 56 is withdrawn to the hydrogen-water filter 70 by a liquid feeding pump 73 which is placed at the midpoint of a hydrogen-water recovery pipe 72, and similarly, the used ozone water (waste water) drained through the outlet of the ozone-water-used ultrasonic cleaning nozzle 56 is withdrawn to the ozone-water filter 71 by a liquid feeding pump 75 which is placed at the midpoint of an ozone-water recovery pipe 74.

The hydrogen water passed through the hydrogen-water filter 70 is supplied to the hydrogen-water-used ultrasonic cleaning nozzle 55 by a liquid feeding pump 77 which is placed at the midst of a recycled hydrogen-water supply pipe 76. Similarly, the ozone water passed through the ozone-water filter 71 is supplied to the ozone-water-used ultrasonic cleaning nozzle 56 by a liquid feeding pump 79 which is placed at the midst of a recycled ozone-water supply pipe 78. The hydrogen-water supply pipe 66 and the recycled hydrogen-water supply pipe 76 are connected before the hydrogen-water-used ultrasonic cleaning nozzle 55, and the supply of new hydrogen water to the hydrogen-water-used ultrasonic cleaning nozzle 55 and the supply of recycled hydrogen water thereto can be switched by a valve 80. Similarly, the ozone-water supply pipe 68 and the recycled ozone-water supply pipe 78 are connected before the ozone-water-used ultrasonic cleaning nozzle 56, and the supply of new ozone water to the ozone-water-used ultrasonic cleaning nozzle 56 and the supply of recycled ozone water thereto can be switched by a valve 81. While hydrogen water and ozone water passed through the filters 70 and 71 have been cleaned of particles, the gas contents thereof have been decreased. Therefore, the hydrogen water and ozone water may be returned to the hydrogen water producing device 64 and the ozone water producing device 65 through the pipes so that they can be resupplied with hydrogen gas and ozone gas.

The loader cassette 58 and the unloader cassette 59 are detachably mounted on the side of the cleaning section 52. The two cassettes 58 and 59 have the same shape and can contain a plurality of substrates W. The loader cassette 58 contains substrates W which have not been subjected to cleaning (wet treatment), and the unloader cassette 59 contains substrates W which have been subjected to cleaning (wet treatment). The substrate transfer robot 57 is placed among the cleaning section 52, the loader cassette 58, and the unloader cassette 59. The substrate transfer robot 57 includes an arm 82 which has an extendable link mechanism at the top thereof. The arm 82 can rotate and vertically move, and can support and transfer a substrate W at the leading end thereof.

Operations of the components of the cleaning apparatus 51 having the above configuration are automatically performed under the control of the control section except that various cleaning conditions, such as the distances between the cleaning nozzles 54, 55, 56, and 89 and the substrate W, the moving speeds of the cleaning nozzles, the flow rate of the cleaning liquid, are set by the operator. Therefore, when using the cleaning apparatus 51, the operator loads unclean substrates in the loader cassette 58 and operates a start switch, and the substrates W are then conveyed from the loader cassette 58 onto the stage 53 by the substrate transfer robot 57 so as to be automatically and sequentially subjected to ultraviolet cleaning, ultrasonic cleaning with hydrogen water, ultrasonic cleaning with ozone water, and rinsing by the cleaning nozzles 54, 55, 56, and 89. After the cleaning processes, the substrates W are put into the unloader cassette 59 by the substrate transfer robot 57.

Since the cleaning apparatus 51 includes the cleaning nozzles 55 and 56 according to the above embodiments, and the above-described nozzle and workpiece relatively moving means, the entire cleaning region of the substrate W can be cleaned while maintaining the advantages of the cleaning nozzles.

Since the four cleaning nozzles 54, 55, 56, and 89 adopt different cleaning methods, namely, ultraviolet cleaning, ultrasonic cleaning with hydrogen water, ultrasonic cleaning with ozone water, and rinsing, the single cleaning apparatus 51 can carry out various cleaning methods. Accordingly, various types of substances can be satisfactorily removed by, for example, removing fine particles by ultrasonic cleaning with hydrogen water and ozone water and then performing finish-cleaning while washing out the cleaning liquid adhering to the surface of the substrate by rinsing. Furthermore, since the cleaning apparatus 51 has the above-described liquid-saving cleaning nozzles, the consumption of the cleaning liquid can be reduced. Moreover, since the cleaning liquid will not accumulate at the bottoms of the nozzles, substrate cleaning with higher efficiency and a higher level of cleanliness is possible. Consequently, it is possible to provide a cleaning apparatus suitable for production lines of various electronic devices, such as semiconductor devices and liquid crystal display panels.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. For example, the shapes and sizes of the cleaning nozzles, the number and positions of the supply pipes and drain pipes of the cleaning nozzles, and the like may be appropriately changed. While the nozzle of the present invention is applied to cleaning in the above embodiments, it may also be applicable to other wet treatments such as etching and resist removal.

### EXPERIMENTAL EXAMPLES

While the present invention will be more specifically described below through experimental examples, it is not limited to the examples.

As a first example, a cleaning nozzle similar to that shown in FIGS. 1 and 2 was produced. In the cleaning nozzle of the first example, a diaphragm and a side plate were integrally molded to form a box, and were made of SUS316L. The thickness of the diaphragm was set within the range of 3 mm+0.2 mm. A groove (thin portion) was formed on the upper surface of the diaphragm by machining so as to surround an area where a vibrator body is placed. The depth D₁ and width W₁ of the groove were set at 2.5 mm and 2 mm, respectively. The distance between the groove and the inner surface of the side plate was 1 mm. The width and length of the vibrator body bonded to the upper surface of the diaphragm were set at 33 mm and 165 mm, respectively, and the distance between the vibrator body and the inner surface of the side plate was set at approximately 15 mm. The width W₃ of the cleaning nozzle (excluding the widths of a supply pipe and a drain pipe) was set at 69 mm. The frequency of ultrasonic vibration applied from the vibrator body was 0.95 MHz, and the wavelength of the ultrasonic vibration inside the diaphragm was approximately 6 mm.

For comparison, a cleaning nozzle similar to that of the first example except that no groove was formed on the upper surface of the diaphragm was produced as a first comparative example. The width W₅ of the cleaning nozzle (excluding the widths of a supply pipe and a drain pipe) was set at 69 mm. The cleaning nozzle of the first comparative example had a structure similar to that of the conventional cleaning nozzle shown in FIG. 13.

As a second example, a cleaning nozzle similar to that shown in FIGS. 4 and 5 was produced. In the cleaning nozzle of the second example, a diaphragm and a side plate were integrally molded to form a box, and were made of SUS316L. The thickness of the diaphragm was set within the range of 3 mm±0.2 mm. A groove (thin portion) was formed on the border between the diaphragm and the side plate (on the periphery of the inner bottom of the box) by machining. The depth D₂ and width W₂ of the groove were set at 2.0 mm and 2 mm, respectively. The distance between the groove and a vibrator body bonded to the upper surface of the diaphragm was set at 1 mm. The width and length of the vibrator body were set at 33 mm and 165 mm, respectively. The width W₄ of the cleaning nozzle (excluding the widths of a supply pipe and a drain pipe) was set at 41 mm. The frequency of ultrasonic vibration applied from the vibrator body was 0.95 MHz, and the wavelength of the ultrasonic vibration inside the diaphragm was approximately 6 mm.

For comparison, a cleaning nozzle similar to that of the second example except that no groove was formed on the border between a diaphragm and a side plate was produced as a second comparative example.

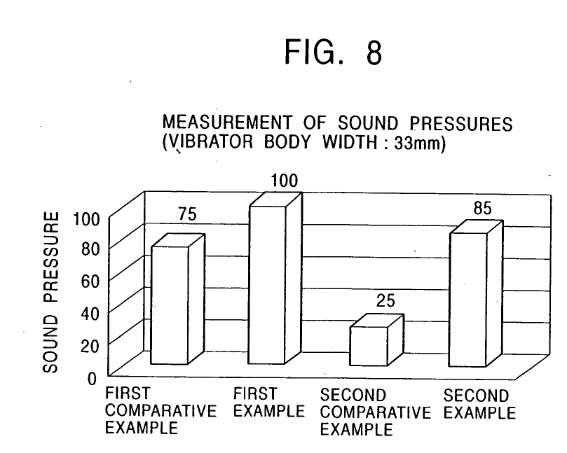

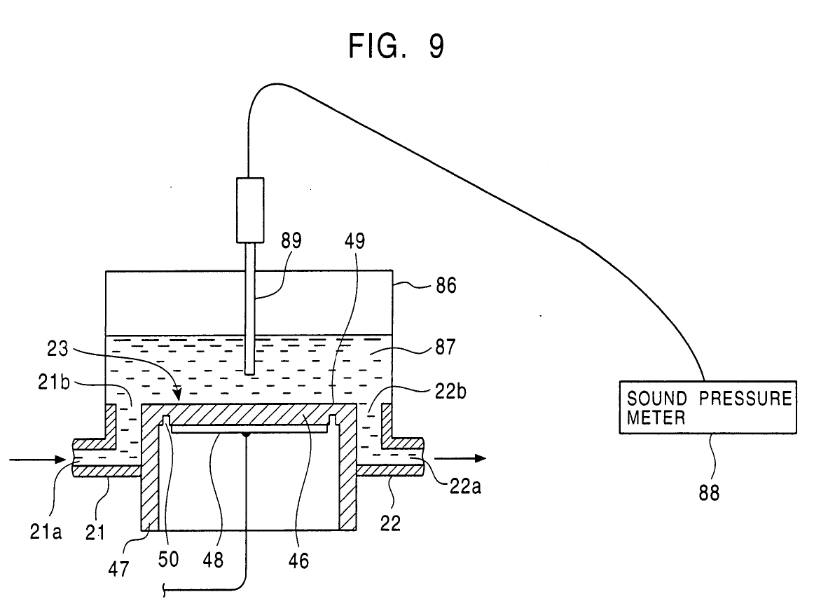

The radiation efficiencies of ultrasonic vibration applied from the vibrator bodies of the cleaning nozzles according to the first and second examples and the first and second comparative examples were examined. FIG. 8 shows the results of the examinations. In order to examine the radiation efficiency of the ultrasonic vibration, as shown in FIG. 9, a beaker 86 having an opening at the bottom was placed on the side of the first and second openings 21b and 22b of the cleaning nozzle, was filled with pure water 87 supplied from the inlet 21a of the supply path 21. When the pure water 87 was discharged from the drain path 22, ultrasonic vibration was applied from the vibrator body 48 to the diaphragm 46. Furthermore, a sound pressure sensor (piezoelectric element) 89 connected to a sound pressure meter 88 was put in the pure water 87 filled in the beaker 86, and the sound pressure (mV) of ultrasonic waves radiated to the pure water 87 through the diaphragm 46 was measured.

FIG. 8 shows the result of comparison of sound pressures of the cleaning nozzles of the second example and the first and second comparative examples with the sound pressure (which was set at 100) of the cleaning nozzle of the first example.

As is evident from FIG. 8, in the cleaning nozzle of the first example in which the groove (thin portion) is formed on the upper surface of the diaphragm so as to surround the area where the vibrator body was placed, the radiation efficiency of ultrasonic radiation applied from the vibrator body to the treatment liquid through the diaphragm is higher because the sound pressure of the ultrasonic waves radiated to the ultrapure water is higher than that in the cleaning nozzle of the first comparative example in which no groove is formed on the upper surface of the diaphragm. In addition, in the cleaning nozzle of the second example in which the groove (thin portion) is formed on the border between the diaphragm and the side plate, the radiation efficiency of ultrasonic vibration applied from the vibrator body to the treatment liquid through the diaphragm is higher because the sound pressure of the ultrasonic waves radiated to the ultrapure water is higher than that in the cleaning nozzle of the second comparative example in which no groove is formed on the border between the diaphragm and the side plate.

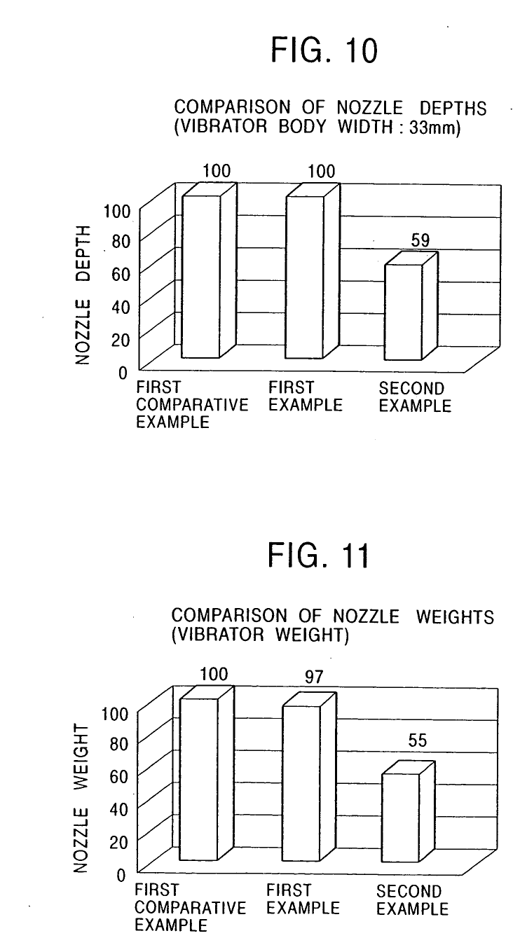

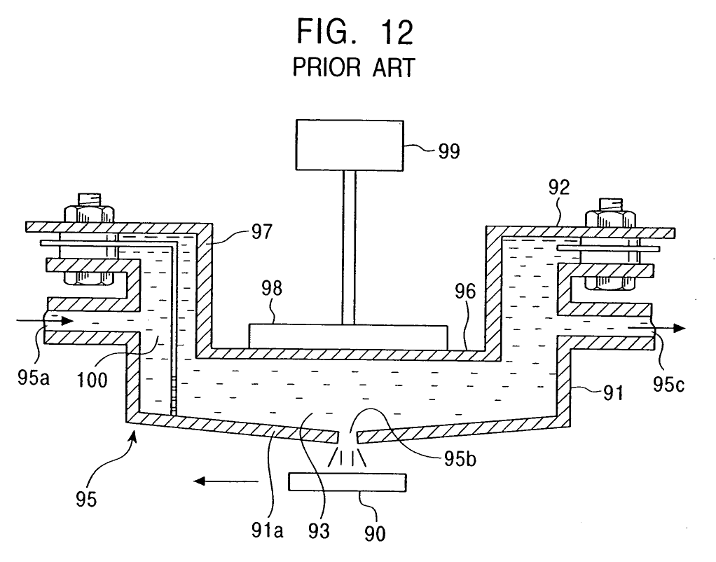

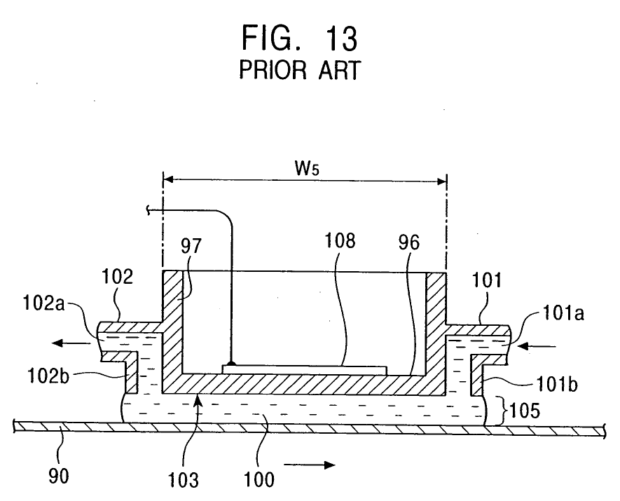

FIG. 10 shows the result of comparison of the widths (excluding the widths of the supply pipe and the drain pipe) of the cleaning nozzles of the first and second examples and the first comparative example. In FIG. 10, the widths W₄ and W₅ of the cleaning nozzles of the second example and the first comparative example were compared with the width W₃ (which was set at 100) of the cleaning nozzle of the first example. As is evident from the results shown in FIGS. 8 and 10, the cleaning nozzle of the second example secures an ultrasonic radiation efficiency equal to 85% of that of the cleaning nozzle of the first example, although the width W₄ thereof is approximately 60% of those of the cleaning nozzles of the first example and the first comparative example. This shows that size reduction can be achieved by the present invention.

FIG. 11 shows the result of comparison of the weights of the cleaning nozzles of the first and second examples and the first comparative example (the weights of the diaphragms). In FIG. 11, the weights (masses) of the diaphragms in the cleaning nozzles of the first and second examples were compared with the weight (mass) (which was set at 100) of the diaphragm in the cleaning nozzle of the first comparative example. FIG. 11 shows that the weight of the cleaning nozzle of the second example is about half the weight of the cleaning nozzle of the first comparative example, and that weight reduction is possible.

What is claimed is:

1. An ultrasonic vibrator comprising:
a vibrating portion;
a side wall portion standing on the principal surface of said vibrating portion; and
a vibrator body disposed on the principal surface of said vibrating portion inside said side wall portion so as to apply ultrasonic vibration to said vibrating portion,
wherein said vibrating portion has a thin portion formed at least in a part of the periphery of an area where said vibrator body is placed.

2. An ultrasonic vibrator comprising:
a vibrating portion;
a side wall portion standing on the principal surface of said vibrating portion; and
a vibrator body disposed on the principal surface of said vibrating portion inside said side wall portion so as to apply ultrasonic vibration to said vibrating portion,
wherein a thin portion is formed at least on a part of the border between said vibrating portion and said side wall portion.

3. An ultrasonic vibrator according to claim 1, wherein the thickness of said vibrating portion is within the range of λ/2±0.3 mm, where λ represents the wavelength inside said vibrating portion of ultrasonic vibration applied from said vibrator body.

4. An ultrasonic vibrator according to claim 2, wherein the thickness of said vibrating portion is within the range of λ/2±0.3 mm, where λ represents the wavelength inside said vibrating portion of ultrasonic vibration applied from said vibrator body.

5. An ultrasonic vibrator according to claim 1, wherein the frequency of the ultrasonic vibration is within the range of 20 kHz to 10 MHz.

6. An ultrasonic vibrator according to claim 2, wherein the frequency of the ultrasonic vibration is within the range of 20 kHz to 10 MHz.

7. A wet-treatment nozzle for supplying a treatment liquid for wet treatment of a workpiece toward the workpiece and for discharging the waste treatment liquid after the wet treatment, said nozzle comprising:
a supply pipe having, at one end, an inlet for admitting the treatment liquid;
a drain pipe having, at one end, an outlet for draining the waste liquid to the outside; and
a connecting portion facing the workpiece so as to connect the other ends of said supply pipe and said drain pipe,
wherein said connecting portion has a first opening which opens to said supply pipe and a second opening which opens to said drain pipe,
wherein a treatment region for the wet treatment that is filled with the treatment liquid is formed in a space between the opposing surfaces of said connecting portion and the workpiece by supplying the treatment liquid from said first opening toward the workpiece,
wherein said connecting portion includes an ultrasonic vibrator according to claim 1 for applying ultrasonic vibration to the treatment liquid in said treatment region, and
wherein the waste liquid from said treatment region is guided from said second opening into said drain pipe and is drained through said outlet.

8. A wet-treatment nozzle for supplying a treatment liquid for wet treatment of a workpiece toward the workpiece and for discharging the waste treatment liquid after the wet treatment, said nozzle comprising:
a supply pipe having, at one end, an inlet for admitting the treatment liquid;
a drain pipe having, at one end, an outlet for draining the waste liquid to the outside; and
a connecting portion facing the workpiece so as to connect the other ends of said supply pipe and said drain pipe,
wherein said connecting portion has a first opening which opens to said supply pipe and a second opening which opens to said drain pipe,
wherein a treatment region for the wet treatment that is filled with the treatment liquid is formed in a space between the opposing surfaces of said connecting portion and the workpiece by supplying the treatment liquid from said first opening toward the workpiece,
wherein said connecting portion includes an ultrasonic vibrator according to claim 2 for applying ultrasonic vibration to the treatment liquid in said treatment region, and
wherein the waste liquid from said treatment region is guided from said second opening into said drain pipe and is drained through said outlet.

9. A wet-treatment apparatus comprising:
a wet-treatment nozzle according to claim 7; and
a nozzle and workpiece relatively moving means for cleaning the entire treatment region of a workpiece by relatively moving said wet-treatment nozzle and the workpiece along the surface of the workpiece.

10. A wet-treatment apparatus comprising:
a wet-treatment nozzle according to claim 8; and
a nozzle and workpiece relatively moving means for cleaning the entire treatment region of a workpiece by relatively moving said wet-treatment nozzle and the workpiece along the surface of the workpiece.
